(19) United States
(12) Patent Application Publication
(10) Pub. No.: US 2026/0095037 A1
(43) Pub. Date: Apr. 2, 2026

(54) METHODS AND APPARATUS TO MITIGATE ELECTROTHERMAL DAMAGE IN CLAMPING CIRCUITS

(71) Applicant: Texas Instruments Incorporated, Dallas, TX (US)

(72) Inventors: Ashish Ojha, Bangalore (IN); Shailendra Verma, Aligarh (IN)

(21) Appl. No.: 18/902,295

(22) Filed: Sep. 30, 2024

(51) Int. Cl. H02H 3/02; H02H 3/08

(52) U.S. Cl. CPC H02H 3/021; H02H 3/08

(57) ABSTRACT

An example apparatus includes: voltage clamping circuitry having first, second, third, and fourth terminals; a first transistor having a gate terminal coupled to the third terminal of the voltage clamping circuitry, a drain terminal coupled to the first terminal of the voltage clamping circuitry, and a source terminal coupled to the second terminal of the voltage clamping circuitry; a second transistor having a gate terminal, a drain terminal coupled to the drain terminal of the first transistor, and a source terminal coupled to the source terminal of the first transistor; and a third transistor having a gate terminal coupled to the fourth terminal of the voltage clamping circuitry, a drain terminal coupled to the gate terminal of the first transistor, and a source terminal coupled to the gate terminal of the second transistor.

### TECHNICAL FIELD

This description relates generally to high power transistors and, more particularly, to methods and apparatus to mitigate electrothermal damage in clamping circuits.

### BACKGROUND

Solenoids are used in a wide variety of automotive and industrial applications. Solenoids are electromagnetic actuators that convert electrical current to linear or rotational motion using a wire coil. A solenoid driver circuit refers to an electrical circuit that provides power to a solenoid device with specific current, voltage, and timing characteristics, thereby actuating or de-actuating the solenoid device to perform a desired function. Solenoid driver circuits also utilize techniques to dissipate energy stored in the solenoid device after actuation or de-actuation.

### SUMMARY

For methods and apparatus to mitigate transistor electrothermal damage, an example apparatus includes: voltage clamping circuitry having first, second, third, and fourth terminals; a first transistor having a gate terminal coupled to the third terminal of the voltage clamping circuitry, a drain terminal coupled to the first terminal of the voltage clamping circuitry, and a source terminal coupled to the second terminal of the voltage clamping circuitry; a second transistor having a gate terminal, a drain terminal coupled to the drain terminal of the first transistor, and a source terminal coupled to the source terminal of the first transistor; and a third transistor having a gate terminal coupled to the fourth terminal of the voltage clamping circuitry, a drain terminal coupled to the gate terminal of the first transistor, and a source terminal coupled to the gate terminal of the second transistor.

A second example apparatus includes voltage clamping circuitry having first, second, third, and fourth terminals; a first transistor having a gate terminal coupled to the third terminal of the voltage clamping circuitry, a drain terminal coupled to the first terminal of the voltage clamping circuitry, and a source terminal coupled to the second terminal of the voltage clamping circuitry; a second transistor having a gate terminal, a drain terminal coupled to the drain terminal of the first transistor, and a source terminal coupled to the source terminal of the first transistor; a third transistor having a gate terminal coupled to the fourth terminal of the voltage clamping circuitry, a drain terminal coupled to the gate terminal of the first transistor, and a source terminal coupled to the gate terminal of the second transistor; a fourth transistor having a gate terminal, a drain terminal coupled to the gate terminal of the first transistor, and a source terminal coupled to the gate terminal of the second transistor; and Over Current Protection (OCP) circuitry coupled to the gate terminal of the fourth transistor.

A third example apparatus includes voltage clamping circuitry having a first terminal coupled to a supply voltage terminal, a second terminal coupled to a ground terminal, a third terminal, and a fourth terminal; a first transistor having a gate terminal coupled to the third terminal of the voltage clamping circuitry, a drain terminal coupled to the supply voltage terminal, and a source terminal coupled to the ground terminal; a second transistor having a gate terminal, a drain terminal coupled to the supply voltage terminal, and a source terminal coupled to the ground terminal; a third transistor having a gate terminal coupled to the fourth terminal of the voltage clamping circuitry, a drain terminal coupled to the gate terminal of the first transistor, and a source terminal coupled to the gate terminal of the second transistor; a resistor having a first terminal coupled to the gate terminal of the second transistor and a second terminal; a fourth transistor having a gate terminal coupled to the fourth terminal of the voltage clamping circuitry, a drain terminal coupled to the second terminal of the resistor, and a source terminal coupled to the ground terminal; fifth transistor having a gate terminal, a drain terminal coupled to the supply voltage terminal, and a source terminal coupled to the third terminal of the voltage clamping circuitry; and a sixth transistor having a gate terminal, a drain terminal coupled to the source terminal of the fifth transistor, and a source terminal coupled to the ground terminal

### BRIEF DESCRIPTION OF THE DRAWINGS

FIG. 1 is a block diagram of an example environment that includes solenoid driver circuitry.

FIG. 2 is a block diagram of an example implementation of the solenoid driver circuitry of FIG. 1.

FIG. 3 is a graph representing the thermal stability of the driver architecture of FIG. 2.

FIG. 4A is a schematic diagram of an example implementation of the driver architecture of FIG. 2 when in power delivery mode.

FIG. 4B is a schematic diagram of an example implementation of the driver architecture of FIG. 2 when in clamping mode.

FIG. 4C is a schematic diagram of an example implementation of the driver architecture of FIG. 2 when in Over Current Protection (OCP) Fault mode.

FIG. 5A is an example representation of an Integrated Circuit (IC) that implements the multi-fingered transistor of FIGS. 4A and 4C when in power delivery mode or an OCP fault occurs.

FIG. 5B is an example representation of an IC that implements the multi-fingered transistor of FIG. 4B when in clamping mode.

FIG. 6 is a schematic diagram of an example implementation of the Over Current Protection (OCP) circuitry of FIG. 2.

FIG. 7A are example graphs showing the performance of the driver architecture circuitry of FIG. 2 without a transistor to support an OCP fault.

FIG. 7B are example graphs showing the performance of the driver architecture circuitry of FIG. 2 with a transistor to support an OCP fault.

FIG. 8 is a block diagram of an example processing platform including programmable circuitry structured to execute, instantiate, or perform example machine-readable instructions or perform example operations to implement the control circuitry or driver control circuitry of FIGS. 1 and 2.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

One technique used to dissipate energy in a solenoid device is clamping. Generally, clamping involves the use of a transistor and a Zener diode to rapidly reduce current through an inductive load (e.g., the solenoid device). Clamping circuits may be implemented in solenoid use cases that require minimal de-actuation delays. In contrast, solenoid use cases that can support longer de-actuation delays may dissipate energy using different techniques (e.g., through a freewheeling diode).

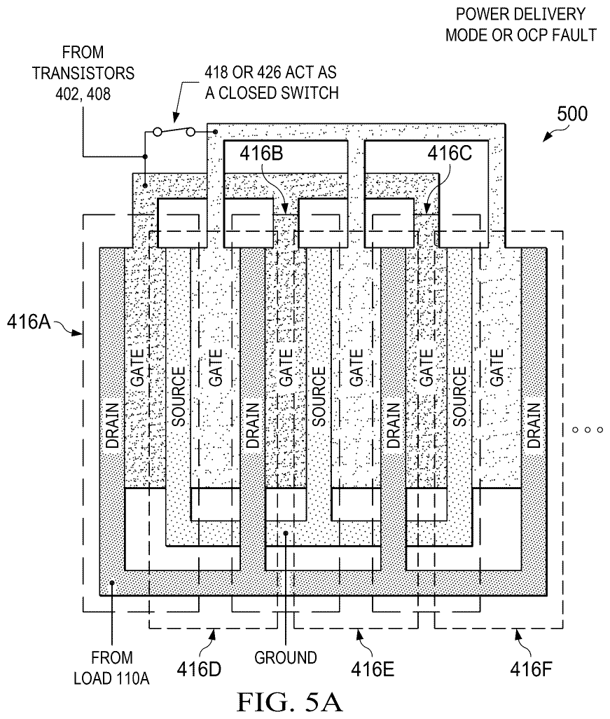

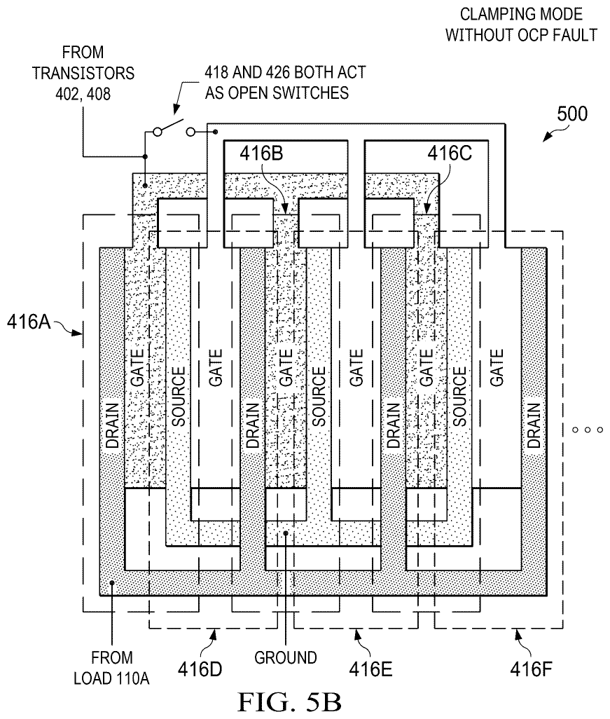

During energy dissipation operations, clamping circuits keep the voltage across the transistor at a constant voltage until the current flowing through the load has decreased to approximately zero amps. In some examples, maintaining a constant voltage across a clamping circuit transistor may be referred to as clamping the voltage. Recently, designers and manufacturers of solenoid driver circuits have used newer transistors that support a greater amount of current flow per Volt applied across the transistor than previous generations. In many examples, the current flows through the transistor across multiple fingers, which are regions of an integrated circuit (IC) that implement a gate terminal. As shown in FIGS. 5A and 5B and described below, a given region of an IC may include multiple fingers that function together.

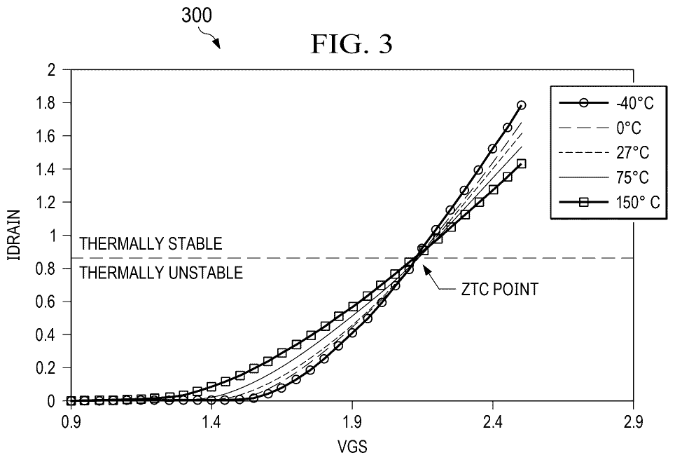

Manufacturers or designers of transistors can add width to an existing transistor design by either: a) increasing the width of existing transistor fingers in the design or b) adding additional fingers to the design. In some use cases that include but are not limited to solenoid driver circuits, adding width to the transistor can improve performance in a power delivery mode when compared to a transistor that has less width. However, the additional width can also cause the transistor to become less thermally stable when operating in clamping mode. Such thermal instability can lead to electrothermal damage is described further in connection with FIG. 3. Accordingly, previous solenoid driver circuits cannot both: a) improve performance in power delivery mode by extending the width of the transistor and b) operate in clamping mode safely when dissipating energy from the load.

Example methods, apparatus and systems described herein describe solenoid driver circuitry that includes additional transistor fingers and supports clamping mode. When the solenoid driver circuitry is providing energy to the load, all of the fingers are powered ON and helping draw current from a first current terminal (e.g., a drain) to a second current terminal (e.g., a source). The solenoid driver circuitry includes additional components so that when energy is being dissipated from the load in clamping mode, a portion of the fingers remain powered ON while the other portion turns OFF. The fingers powered ON and the fingers powered OFF are interleaved between each other, thereby preventing local heating and hotspots from occurring on the IC region that implements the transistor fingers. The solenoid driver circuitry also includes components that can override the clamping mode and keep all fingers powered ON if needed to support an OCP fault.

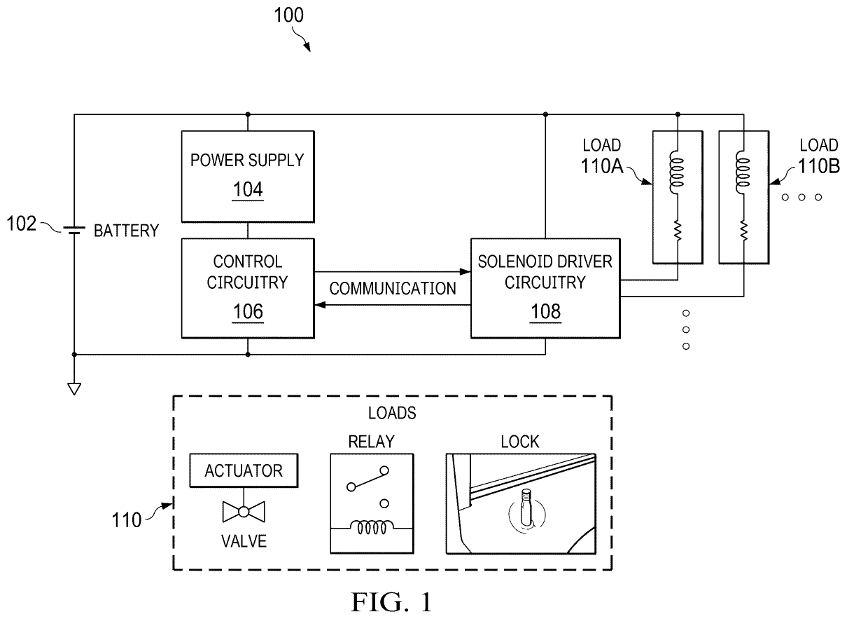

FIG. 1 is a block diagram of an example environment 100 that includes solenoid driver circuitry 108. The environment 100 also includes an example battery 102, an example power supply 104, example control circuitry 106, and example loads 110A, 110B . . . (collectively referred to as loads 110). The environment 100 may refer to any use case that includes loads 110 with solenoids (e.g., automotive applications, industrial applications, etc.)

The battery 102 has a negative terminal coupled to a ground terminal and a positive terminal coupled to the power supply 104, the solenoid driver circuitry 108, and the loads 110. The battery 102 charges the foregoing components at an appropriate current and voltage.

The power supply 104 converts a first current and voltage received from the battery 102 into a second current and voltage that can safely power the control circuitry 106. The control circuitry 106, in turn, manages the operations of the other components in the environment 100. For example, the control circuitry 106 determines when the individual loads 110A, 110B switch from receiving energy to dissipating energy. The control circuitry 106 communicates with the solenoid driver circuitry 108 to cause one or more of the loads 110 to switch between power reception and power dissipation. In some examples, the control circuitry 106 changes a mode of operation of a load 110A responsive to communications with the load 110A itself or responsive to communications within an external device (e.g., an Electronic Control Unit (ECU) within a vehicle).

The control circuitry 106 may be instantiated (e.g., creating an instance of, bring into being for any length of time, materialize, implement, etc.) by programmable circuitry such as a Central Processor Unit (CPU) executing first instructions. Also or alternatively, the control circuitry 106 of FIG. 1 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 1 may, thus, be instantiated at the same or different times. Some or all of the circuitry of FIG. 1 may be instantiated, for example, in one or more threads executing concurrently on hardware or in series on hardware. Moreover, in some examples, some or all of the circuitry of FIG. 1 may be implemented by microprocessor circuitry executing instructions or FPGA circuitry performing operations to implement one or more virtual machines or containers.

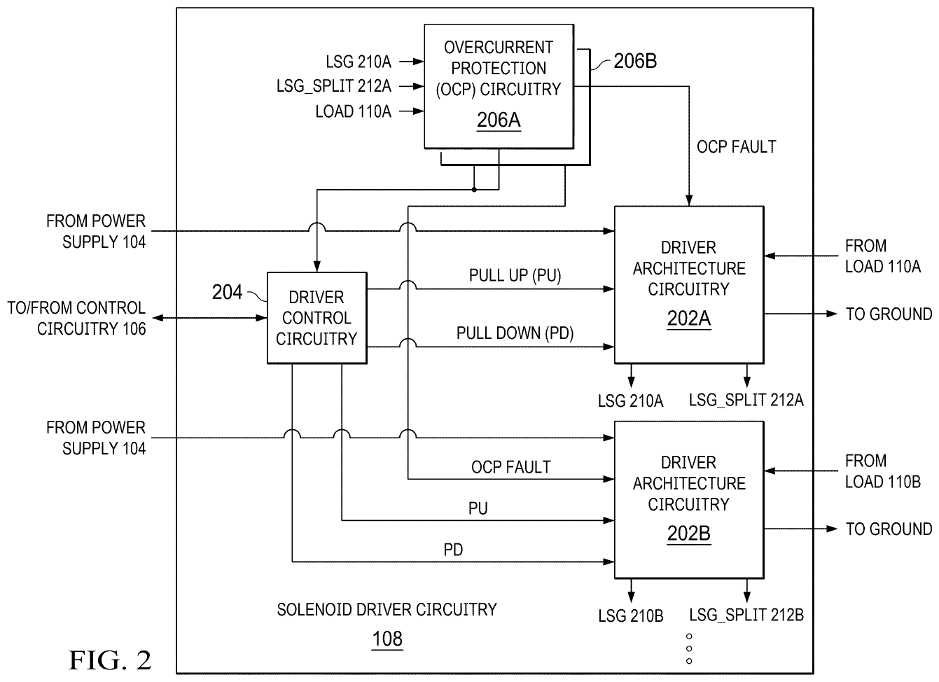

The solenoid driver circuitry 108 supports power delivery and power dissipation to and from the loads 110. The solenoid driver circuitry 108 includes at least one transistor with multiple fingers per load. When the control circuitry 106 indicates a load 110A is in power delivery mode, the solenoid driver circuitry 108 uses all of the fingers on the appropriate transistor to connect a terminal of the load 110A to the ground terminal, thereby completing a closed circuit between the battery 102, the load 110A, and the ground terminal. When the control circuitry 106 indicates the load 110A is dissipating power (e.g., in clamping mode), the solenoid driver circuitry 108 uses only a portion of the transistor fingers to pull current from the load 110A. The solenoid driver circuitry 108 is described further in connection with FIG. 2.

The loads 110 refer to any type of solenoid devices. Such devices may include but are not limited to valves, relays, locks, etc. Accordingly, the loads 110 are represented schematically in the example of FIG. 1 with an inductor and resistor in series. While the example of FIG. 1 shows two loads 110A and 110B, the environment 100 and the examples described herein may support any number of loads 110. A given load 110A may be referred to as an external device with respect to the solenoid driver circuitry 108.

FIG. 2 is a block diagram of an example implementation of the solenoid driver circuitry of FIG. 1. The solenoid driver circuitry 108 includes example driver architecture circuitry 202A, 202B, . . . (collectively driver architecture circuits 202), example driver control circuitry 204, and example Over Current Protection (OCP) circuitry 206A, 206B . . . (collectively OCP circuits 206).

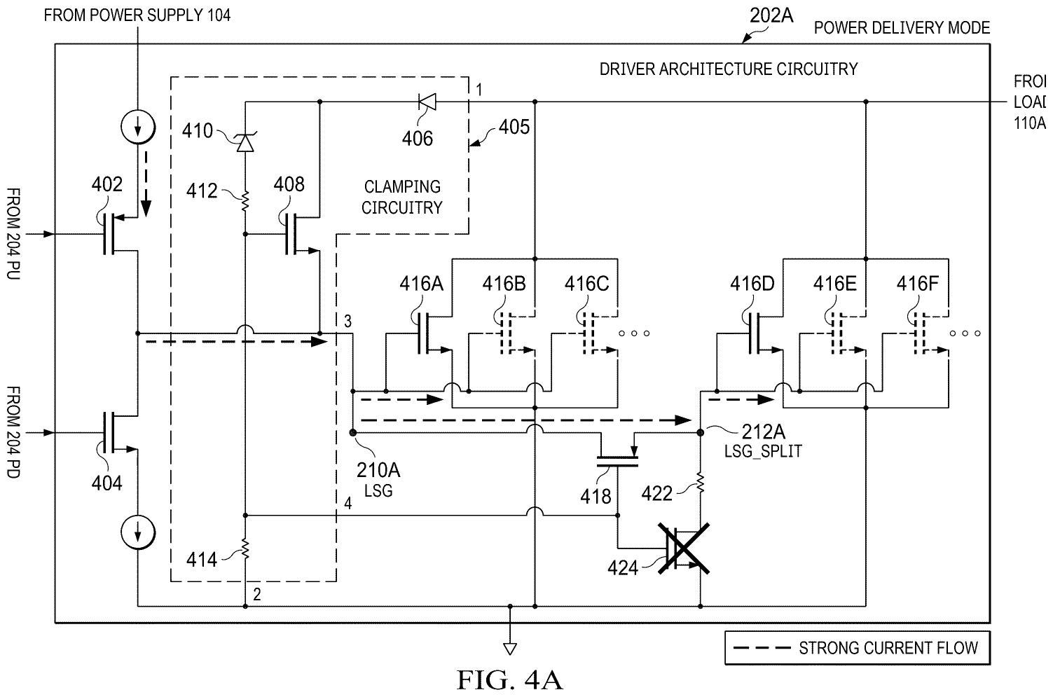

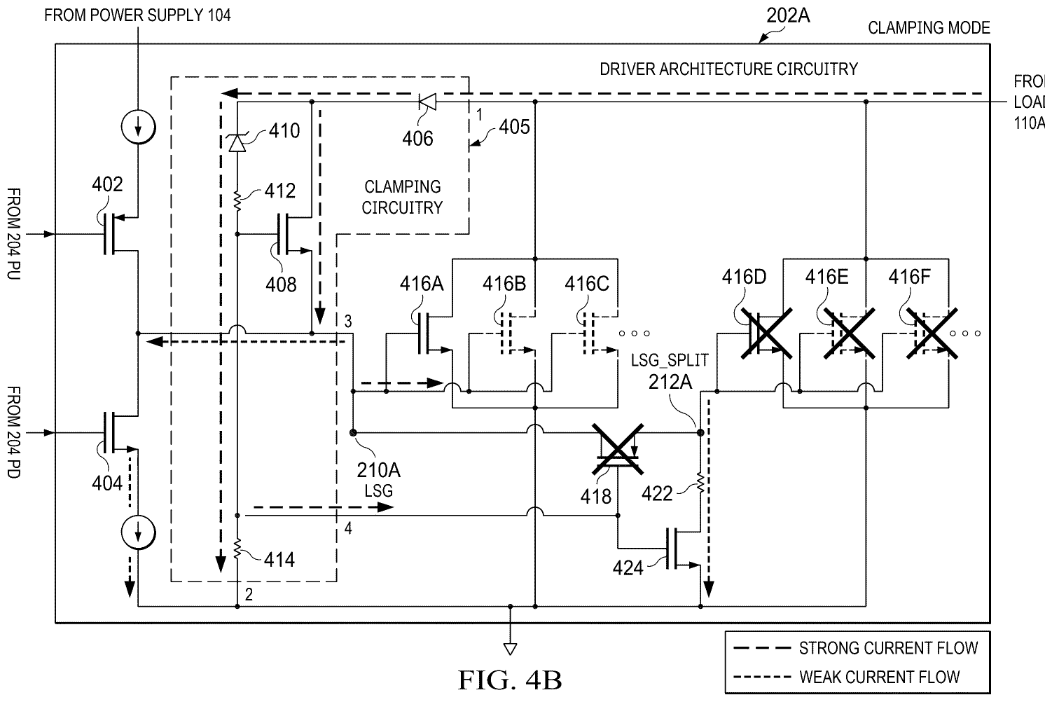

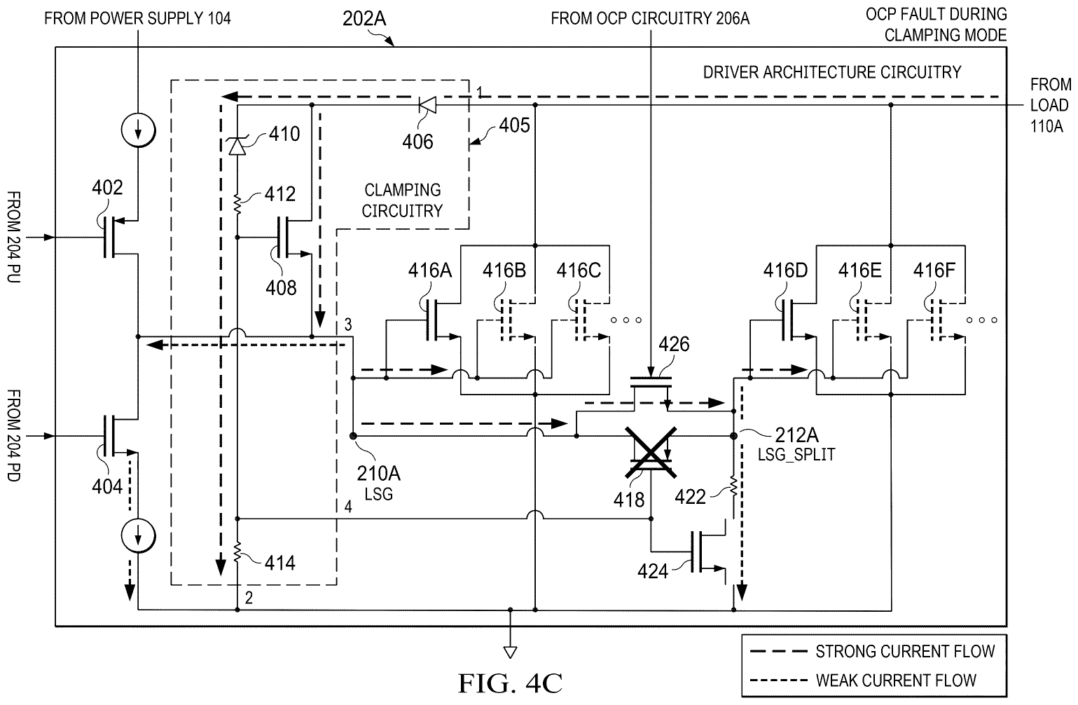

The solenoid driver circuitry 108 includes one instance of the driver architecture circuitry 202A per load 110A. Thus, the solenoid driver circuitry 108 may include any number of driver architecture circuits. A given driver architecture circuit 202A includes a first terminal coupled to the respective load 110A, a second terminal coupled to the ground terminal, a third terminal coupled to the power supply 104, fourth and fifth terminals coupled the driver control circuitry 204, and a sixth terminal coupled to the respective OCP circuitry 206A. In examples described herein, the driver architecture circuitry 202A also outputs a Low Side Gate (LSG) signal 210A and an LSG_SPLIT signal 212A. The driver architecture circuits 202 are described further in connection with FIGS. 4A-4C.

The driver control circuitry 204 has a first terminal coupled to the control circuitry 106 of FIG. 1 and a second terminal coupled to the OCP circuits 206. The driver control circuitry 204 also includes terminals used to transmit unique Pull Up (PU) signals and Pull Down signals to the driver architecture circuits 202. As described further in connection with FIGS. 4A and 4B, the PU and PD signals are used to switch a corresponding driver architecture circuit between power delivery mode and clamping mode. Thus, the driver control circuitry 204 can manage the driver architecture circuitry 202A and the corresponding load 110A independently from the driver architecture circuitry 202B and the corresponding load 110B. The driver control circuitry 204 sets the voltage in the PU and PD signals based on instructions from the control circuitry 106.

The OCP circuitry 206A uses the LSG signal 210A and the LSG_SPLIT signal 212A to determine when the load 110A is exhibiting an OCP fault. Similarly, the OCP circuitry 206B uses the LSG signal 210B and the LSG_SPLIT signal 212B to determine when the load 110B is exhibiting an OCP fault. When one of the OCP circuits 206 detects an OCP fault, it informs both the driver control circuitry 204 and the corresponding driver architecture circuit 202. In the example of FIG. 2, the solenoid driver circuitry 108 includes one OCP circuitry 206A instance per driver architecture circuitry 202A instance. In other examples, the solenoid driver circuitry 108 includes one OCP circuit 206 that supports all the driver architecture circuits 202.

As used above and herein, an OCP fault refers to an error in which one of the loads 110 causes a short circuit to form within the corresponding one of the driver architecture circuits 202 by coupling the power supply 104 directly to the ground terminal via the Driver Circuity 108. During power delivery mode or clamping mode, the current flowing through the a given driver architecture circuitry 202A instance is determined by the corresponding load 110A. During an OCP fault, however, the load 110A at fault is unable to enforce an upper limit on the amount of current that flows through the corresponding driver architecture circuitry 202A. Thus, the driver architecture circuitry 202A can undergo electrothermal breakdown and become damaged if one or more of the transistor fingers within the circuit are powered OFF when the OCP fault occurs. Advantageously, the driver architecture circuits 202 described in examples herein can: a) keep all transistor fingers powered ON during power delivery mode to exhibit performance improvements over previous generations, b), support clamping mode by turning a group of the transistor fingers OFF during such operations to prevent electrothermal breakdown, and c) turn the same group of transistor fingers back ON whenever an OCP fault occurs to avoid damaging the split FET.

FIG. 3 is a sample graph representing the thermal stability of the driver architecture of FIG. 2. The graph 300 includes an x axis that shows the Gate to Source Voltage (V_{GS}) in Volts, and a y axis that shows the current at the drain terminal (I_{DRAIN}) in Amps, of a muti-fingered transistor within one of the driver architecture circuits 202. The graph 300 also includes curves at −40° C., 0° C., 27° C., 75° C., and 150° C. to show how the performance of the driver architecture circuits 202 changes responsive to temperature.

The graph 300 is separated into two portions by the Zero-temperature coefficient (ZTC) point at approximately <2.1 V_{GS}, 0.85 I_{DRAIN}>. The ZTC point refers to where the a transistor's drain current becomes nearly independent of temperature due to the mutual temperature cancellation of threshold voltage and carrier mobility.

When V_{GS} and I_{DRAIN} are greater than the ZTC point, an increase in temperature causes a decrease in I_{DRAIN}. For example, at V_{GS}=2.4, I_{DRAIN}@−40° C.>I_{DRAIN}@0° C.>I_{DRAIN}@27° C., etc. The decrease in I_{DRAIN}, in turn causes a decrease in temperature. Thus, a given driver architecture circuitry 202A instance is considered thermally stable when V_{GS} and I_{DRAIN} are greater than the ZTC point because, at such time, the relationship between temperature and I_{DRAIN} forms a negative feedback loop.

In contrast, when V_{GS} and I_{DRAIN} are less than the ZTC point, an increase in temperature causes an increase in I_{DRAIN}. For example, at V_{GS}=1.9, I_{DRAIN}@−40° C.<I_{DRAIN}@0° C.<I_{DRAIN}@27° C., etc. The increase in I_{DRAIN} in turn causes an additional increase in temperature. Thus, a given driver architecture circuitry 202A instance is considered thermally unstable when V_{GS} and I_{DRAIN} are less than the ZTC point because, at such time, the relationship between temperature and I_{DRAIN} forms a positive feedback loop.

In examples described herein, the value of the I_{DRAIN} is responsive to the power requirements of a load 110A (except during OCP faults) and therefore not controllable by the solenoid driver circuitry 108. Therefore, during clamping mode for the load 110A, the solenoid driver circuitry 108 turns OFF a portion of the transistor fingers in the driver architecture circuitry 202A. The circuit then has the same I_{DRAIN} during both clamping mode and power delivery mode, but fewer fingers powered ON during clamping mode than power delivery mode. Thus, V_{GS} increases when the driver architecture circuitry 202A transitions from power delivery mode to clamping mode. The increase in V_{GS} shifts the circuit from the thermally unstable zone of the graph 300 to the thermally stable zone of the graph 300, thereby mitigating electrothermal breakdown and damage.

In examples described below, the solenoid driver circuitry 108 turns OFF half (50%) of the transistor fingers during clamping mode while the other half (50%) of the transistor fingers remain powered ON. More generally, the solenoid driver circuitry 108 may turn OFF any percentage of the total number of transistor fingers during clamping mode.

FIG. 4A-4C are schematic diagrams of an example implementation of the driver architecture circuitry of FIG. 2. The driver architecture circuitry 202A includes example transistors 402, 404, 408, 416A, 416B, 416C, 416D, 416E, 416F, 418, and 424, example Zener diodes 406 and 410, and example resistors 412, 414, and 422. The Zener Diodes 406 and 410, the transistor 408, and the resistors 412 and 414 may be collectively referred to as clamping circuitry 405. The transistors 416A, 416B, 416C, 416D, 416E, and 416F may be collectively referred to as the transistors 416. While FIGS. 4A-4C show the driver architecture circuitry 202A, the examples described below are applicable to all of the driver architecture circuits 202.

The transistor 402 includes a first current terminal (e.g., a source) coupled to the power supply 104 through a supply voltage terminal, a control terminal (e.g., a gate) coupled to the driver control circuitry 204, and a second current terminal (e.g., a drain). The gate terminal of the transistor 402 is structured to receive a PU signal from the driver control circuitry 204.

The transistor 404 includes a first current terminal (e.g., a drain) coupled to the second current terminal of the transistor 402, a control terminal (e.g., a gate) coupled to the driver control circuitry 204, and a second current terminal (e.g., a source). The gate terminal of the transistor 404 is structured to receive a PD signal from the driver control circuitry 204.

Within the clamping circuitry 405, the Zener diode 406 includes a positive terminal (e.g., an anode) coupled to the load 110A and a negative terminal (e.g., a cathode). The transistor 408 includes a first current terminal (e.g., a source) coupled to the negative terminal of the Zener diode 406, a control terminal (e.g., a gate), and a second current terminal (e.g., a drain) coupled to the second current terminal of the transistor 402. The Zener diode 410 includes a negative terminal (e.g., a cathode) coupled to the negative terminal of the Zener diode 406 and a positive terminal (e.g., an anode). The resistor 412 includes a first terminal coupled to the positive terminal of the Zener diode 410 and a second terminal. The resistor 414 includes a first terminal coupled to the second terminal of the resistor 412 and a second terminal coupled to the ground terminal. In the examples of FIGS. 4A-4C, the clamping circuitry 405 is labelled having a first terminal coupled to the positive terminal of the Zener diode 406, a second terminal coupled to the second terminal of the resistor 414, a third terminal coupled to the drain terminal of the transistor 408, and a fourth terminal coupled to the first terminal of the resistor 414. In some examples, the clamping circuitry 405 is referred to as voltage clamping circuitry.

The transistors 416 may be collectively referred to as a single transistor having multiple fingers because, a) the transistors 416 are collectively implemented within the same region of the IC that includes multiple gate terminal regions, b) the drain terminal regions of the transistors 416 are coupled to one another, and c) the source terminal regions of the transistors 416 are coupled to one another. Therefore, a given transistor 416A that is powered ON enables current to flow from the load 110A (which is coupled to the drain terminal), through the transistor 416A, and to the ground terminal (which is coupled to the source terminal). In examples described herein, the transistors 416 may also be collectively referred to as a Low Side Power FET. In other examples where the solenoid circuitry 108 is implemented into a system using a different configuration than the environment 100 of FIG. 1, the transistors 416 may instead be collectively referred to as a High Side Power FET. In such other examples, the names of the LSG signal 210A and LSG_SPLIT signal 212A change to HSG signal and HSG_SPLIT signal respectively.

While the transistors 416 act similarly and may be referred to as a single transistor, they are shown in the example schematic of FIGS. 4A-4C with one transistor symbol per gate terminal in the IC region. Notably, half of the gate terminals are coupled to one another to form a first electrical node, while the other half of the gate terminals are coupled to one another form a second, separate electrical node. Accordingly, the first half of the transistors 416 (e.g., 416A, 416B, and 416C) are represented schematically as a first group of parallel transistors and the other half of the transistors 416 (e.g., 416D, 416E, and 416F) are represented schematically as a second group of parallel transistors. In the examples of FIG. 4A-4C, the transistors 416 includes six gate terminals represented by two groups of parallel transistors that each include three transistor symbols. In practice, the transistors 416 may include any number of gate terminals (e.g., on the scale of thousands) that interact with shared source and drain terminals.

The examples of FIGS. 4A-4C show that the voltage and current at the gate terminals of the transistors 416A-416C form the LSG signal 210A. The transistors 416A-416C include first current terminals (e.g., a drain) coupled to the load 110A, control terminals (e.g., a gate) coupled to the second current terminal of the transistor 408, and second current terminals (e.g., a source) coupled to the ground terminal.

The transistor 418 includes a first current terminal (e.g., a drain) coupled to the control terminals of the transistors 416A-416C, a control terminal (e.g., a gate) coupled to the first terminal of the resistor 414 within the clamping circuitry 405, and a second current terminal (e.g., a source).

The transistors 416D-416F include a first current terminal (e.g., a drain) coupled to the load 110A, a control terminal (e.g. a gate) coupled to the second current terminal of the transistor 418, and a second current terminal (e.g., a source) coupled to the ground terminal. The current and voltage at the control terminals of the transistors 416D-416F form the LSG_SPLIT signal 212A.

The resistor includes a first terminal coupled to the control terminals of the transistors 416D-416F and a second terminal. The transistor 424 includes a first current terminal (e.g., a drain) coupled to the second terminal of the resistor 422, a control terminal (e.g., a gate) coupled to the first terminal of the resistor 414 within the clamping circuitry 405, and a second current terminal (e.g., a source) coupled to the ground terminal.

In the example of FIGS. 4A-4C, the transistors 404, 408, 416A-416F, and 424 are n-channel metal-oxide semiconductor field-effect transistors (MOSFETs), and the transistors 402 and 418 are p-channel MOSFETs. In other examples, one or more of transistors 402, 404, 408, 418 and 424 is instead implemented with one or more of insulated-gate bipolar transistors (IGBTs), junction field effect transistors (JFETs), bipolar junction transistors (BJTs) or, other transistor devices. The transistors 416A-416F are implemented as a MOSFET in the example of FIGS. 4A-4C because the thermal modeling of FIG. 3 is specific to MOSFETs.

In addition to providing an example schematic diagram, FIG. 4A is annotated to show the operations of the driver architecture circuitry 202A when in power delivery mode. When the control circuitry 106 enables power delivery to the load 110A, the driver control circuitry 204 provides PU and PD signals to the driver architecture circuitry 202A so that the transistor 402 is powered ON and the transistor 404 is powered OFF. Accordingly, current flows from the power supply 104, through the transistor 402, and to the control terminals of the transistors 416A and 416C. The transistor 418 is also powered ON during power delivery mode because no current flows through the clamping circuitry 405. The lack of current through the clamping circuitry also keeps the transistor 424 powered OFF, which prevents current flow from the resistor 422 to the ground terminal. Instead, current flows through the transistor 402, through the transistor 418 (which acts as a closed switch during power delivery mode), and to the control terminal of the transistors 416D-416F. Accordingly, both parallel groups (e.g., all of the fingers) of the transistors 416 are powered ON during the power delivery mode, thereby forming a complete circuit from the battery 102, load 110A, and the ground terminal.

FIG. 4B shows the same example schematic representation of the driver architecture circuitry 202A as FIG. 4A. Accordingly, FIG. 4B includes the same components coupled in the same manner as described above. However, while FIG. 4A is annotated to show current flow while in power delivery mode, FIG. 4B is annotated to show current flow while in clamping mode.

Clamping mode begins when the driver control circuitry 204 receives communication from the control circuitry 106 that indicates energy is being dissipated from the load 110A. In response to the communications, the driver control circuitry 204 sends PU and PD signals to the driver architecture circuitry 202A that turns the transistor 402 OFF and turns the transistor 404 ON. The control circuitry 106 then causes a large amount of current to flow from the load 110A to driver architecture circuitry 202A, thereby dissipating energy from the load 110. The amount of current from the load 110A is sufficiently large to flow through both Zener Diodes 406 and 410, even though the polarity of the Zener diode 410 resists the flow of current in that direction. The current through the Zener diode 410 also flows through the resistors 412 and the control terminal of the transistor 408, thereby turning the transistor 408 ON. After flowing through the Zener diode 406 and transistor 408, a comparatively small amount current (labeled in FIG. 4B as weak current flow) flows through the transistor 404 and to the ground terminal. However, a comparatively large amount of current (labeled in FIG. 4B as strong current flow) flows through the control terminals of the transistors 416A-416C, thereby turning the first parallel group (e.g., half of the fingers) of the transistors 416 ON.

The current that flows through the resistor 412 also flows through the control terminals of the transistors 418 and 424, thereby turning the transistor 418 OFF and turning the transistor 424 ON. Accordingly, the transistor 418 acts as an open switch in clamping mode that turns the second parallel group (e.g., the other half of the fingers) of the transistors 416 OFF. Therefore, the decoupling of the transistors 416D-416F from the transistors 416A-416C prevents the driver architecture circuitry 202A from electrothermal breakdown. Because the transistor 424 is powered ON in clamping mode, any current at the second current terminal of the transistor 418 that existed at the end of power delivery mode (which is labeled as weak current flow) travels through the resistor 422 and to the ground terminal instead of flowing to the control terminals of the transistors 416D-416F. In some examples, clamping mode as shown in FIG. 4B and described in examples herein may be referred to as FET splitting mode because it splits the transistors 416F into two groups that function differently (e.g., half are powered ON and half are powered OFF).

FIG. 4C shows an example schematic representation of the driver architecture circuitry 202A as FIG. 4A. FIG. 4C includes the same components coupled in the same manner as described above with respect to FIGS. 4A and 4B. However, FIG. 4C also includes the transistor 426. The transistor 426 has a first current terminal (e.g., a drain) coupled to the control terminals of the transistors 416A-416C, a control terminal (e.g., a gate) coupled to the OCP circuitry 206A, and a second current terminal coupled to the control terminals of the transistors 416D-416F. Thus, while the transistor 418 functionally acts a switch that separates the first half of the transistors 416 from the second half of the transistors 416, the transistor 426 functionally acts as a switch that sits in parallel with the transistor 418 and offers an alternate path between the two groups of transistor fingers. Notably, the transistor 426 is shown only in the example of FIG. 4C for explanatory purposes. In practice, the transistor 426 may be implemented during the manufacture of the solenoid driver circuitry 108 (along with the other components of the chip) and be present during both power delivery and clamping mode operations.

The parallel paths formed by the transistors 418 and 426 open and close independently of one another. As described above in connection with FIGS. 4A and 4B, the transistor 418 opens and closes (e.g., turns ON and OFF) responsive to the control circuitry 106 transitioning the driver architecture circuitry 202A between power delivery mode and clamping mode. The transistor 426, in contrast, opens and closes responsive to the detection of an OCP fault that may occur at any time due to an error with the load 110A. As described above in connection with FIG. 2, the OCP fault draws an extreme amount of current through the transistors 416 that can result in electrothermal breakdown unless all the transistor fingers are powered ON. However, if the OCP fault happens to occur during clamping mode, the transistor 418 is powered OFF and acts as an open switch.

FIG. 4C is annotated to show the flow of current through the driver architecture circuitry 202A during such operating conditions (e.g., when an OCP fault occurs during clamping mode). In such examples, the OCP circuitry 206A detects the OCP fault and sends a signal that turns the transistor 426 ON. Accordingly, current flow that would otherwise be blocked by the transistor 418 instead flows through the transistor 426 and to the control terminals of the transistors 416D-416F. While some amount of current does flow through the resistor 422 and to the ground terminal (because the transistor 424 is still powered ON from clamping mode), the amount of current is comparatively small (e.g., labelled as weak current flow) compared to the amount of current at the control terminal of the transistors 416D-416F (which is labeled as strong current flow). Accordingly, the transistor 426 ensures that both parallel groups (e.g., all fingers) of the transistors 416 are powered ON during an OCP fault, thereby preventing electrothermal breakdown.

Notably, while FIG. 4C does show all fingers powered ON during clamping mode, OCP fault conditions do not last long enough for the type of electrothermal breakdown described in FIG. 4B to occur. Furthermore, the OCP circuitry 206A provides a signal that keeps the transistor 426 powered OFF whenever an OCP fault is not occurring. Thus, unless an OCP fault occurs, the transistor 418 is the only viable path for current flow to the control terminal 416D-416F. Accordingly, the existence of the transistor 426 does not negate, impede, or otherwise change the use of the transistor 418 to switch between power delivery mode and clamping mode as described in FIGS. 4A and 4B.

FIG. 5A is an example representation of an Integrated Circuit (IC) that implements the multi-fingered transistor of FIGS. 4A and 4C when in power delivery mode or an OCP fault occurs. The example of FIG. 5A is a top-down view of an IC region 500 that implements the transistors 416 (e.g., the Low Side Power FET). The IC region 500 includes rectangular areas that are implemented physically adjacent to one another but fabricated using different materials or techniques to implement various internal components of the transistors 416. For example, the IC region 500 is designed and fabricated so that a rectangular gate region has direct contact with both a drain region and a source region. A single transistor symbol 416A from FIGS. 4A-4C, therefore, represents one drain region, one gate region, and one source region of the IC region 500 that are in direct physical contact with each other (e.g., without intermediate regions between them). Similarly, a “transistor finger” as used above and herein refers to one of the rectangular gate regions shown in FIGS. 5A and 5B.

As shown in FIGS. 4A-4C , the rectangular drain areas in the IC region 500 are electrically coupled to one another and to the load 110A. Similarly, the rectangular source areas in the IC region 500 are electrically coupled to one another and to the ground terminal. While six transistor fingers are shown in the IC region 500 in the example of FIG. 5A, in practice the Power FET may include any number (e.g., thousands) of rectangular gate regions.

In other approaches to implement solenoid driver circuits, all of the rectangular gate regions would also be coupled to one another. However, in examples described herein, half of the gate regions are coupled together to form a first electrical node and the other half of the gate regions are coupled together to form a second, separate electrical node.

FIG. 4C shows that the foregoing electrical nodes are separated by the parallel paths of transistors 418 and 426. FIG. 5A is annotated to show the behavior of the IC region 500 when the solenoid driver architecture circuitry 202A is in power delivery mode. FIG. 5A also represents the behavior of the IC region 500 that occurs during an OCP fault, regardless of whether the fault occurs during power delivery mode or clamping mode. In any of the foregoing use cases, one or both of the transistors 418 and 426 are powered ON and function as a closed switch. Therefore, in FIG. 5A, the current that flows from the transistors 402 or 408 into the gate terminals at the first electrical node also flows into the gate terminals at the second electrical node.

FIG. 5B shows the same example region 500 that implements the low side Power FET as FIG. 4A. Accordingly, FIG. 5B includes the same gate, source, and drain regions coupled in the same manner as described above. However, FIG. 5B is an example representation of the IC region 500 when in clamping mode without an OCP fault. During such conditions, the transistor 418 is powered OFF and acts as an open switch as described in FIG. 4B. The transistor 426 is also powered OFF during such conditions because an OCP fault is not present. Accordingly, current that flows into the gate terminals of the transistors 416A-416C does not also flow into the gate terminals of transistors 416D-416F.

Notably, FIG. 5B shows that the first half of the transistor fingers that remain powered ON during clamping mode are interwoven between the second half of the transistor fingers that are powered OFF at that time. For example, when read from left to right, the IC region 500 implements transistors 416A, then 416D, then 416B, then 416E, then 416C, and then 416F. This interweaving pattern prevents current from flowing in only one portion of the IC region 500 during clamping mode. Such operations could cause local hotspots and overheating on the portion through which current flows. Instead, examples described herein implement a clamping mode that distributes currently evenly throughout the IC region 500, increases V_{GS}, and moves into a thermally stable mode of operation as described above in connection with FIG. 3.

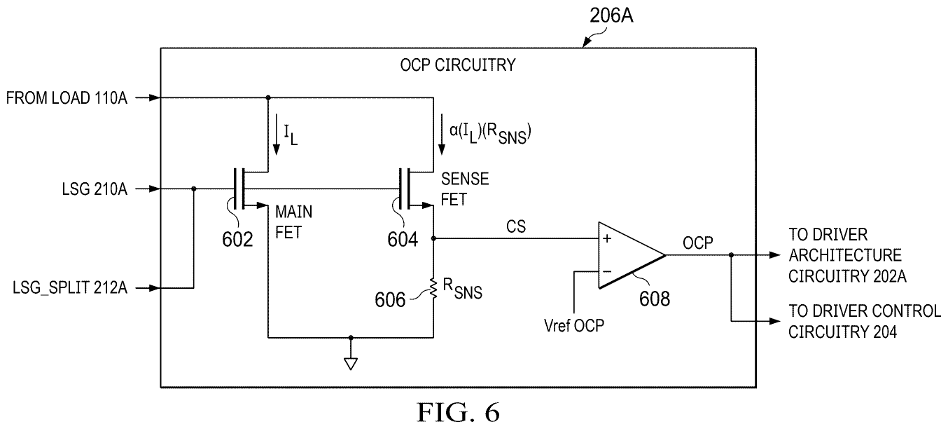

FIG. 6 is a schematic diagram of an example implementation of the Over Current Protection (OCP) circuitry of FIG. 2. The OCP circuitry includes a main FET 602, a sense FET 604, a sense resistor (R_{SNS}) 606, and comparator circuitry 608. The main FET 602 includes a first current terminal (e.g., a drain) coupled to the load 110A, a control terminal structured to receive both the LSG 210A and the LSG_SPLIT 212A signals, and a second current terminal (e.g., a source) coupled to the ground terminal. The sense FET 604 also includes a first current terminal (e.g., a drain) coupled to the load 110A, a control terminal structured to receive both the LSG 210A and the LSG_SPLIT 212A signals, and a second current terminal (e.g., a source). The current and voltage at the second current terminal is labeled in the example of FIG. 6 as the Current Sense (CS) signal.

R_{SNS} 606 includes a first terminal coupled to the second current terminal of the sense FET 604 and a second terminal coupled to the ground terminal. The load 110A provides a current, I_{L}, that flows through both the main FET 602 and the sense FET 604. Accordingly, the voltage at the CS signal is α(I_{L})(R_{SNS}), where α is a constant that represents what fraction of load current is replicated to pass through the sense FET 604.

The comparator circuitry 608 includes a first terminal coupled to the second current terminal of the sense FET 604 and a second terminal structured to receive a reference voltage (V_{REF}) for OCP faults (e.g., a threshold voltage). The comparator circuitry 608 compares the voltage α(I_{L})(R_{SNS}) at the first terminal to V_{REF} at the second terminal. If α(I_{L})(R_{SNS}) is greater than V_{REF}, the comparator circuitry 608 alerts the driver control circuitry 204 that an OCP condition has occurred. Similarly, if α(I_{L})(R_{SNS}) is greater than V_{REF}, the comparator circuitry 608 changes the OCP signal to power the transistor 426 ON as shown in FIG. 4C.

Notably, FIG. 6 describes one example implementation of the OCP circuitry 206A. In other examples, one or more of the OCP circuits 206 are implemented using one or more of: a different analog architecture that performs analog logic operations, or programmable circuitry that performs digital logic operations.

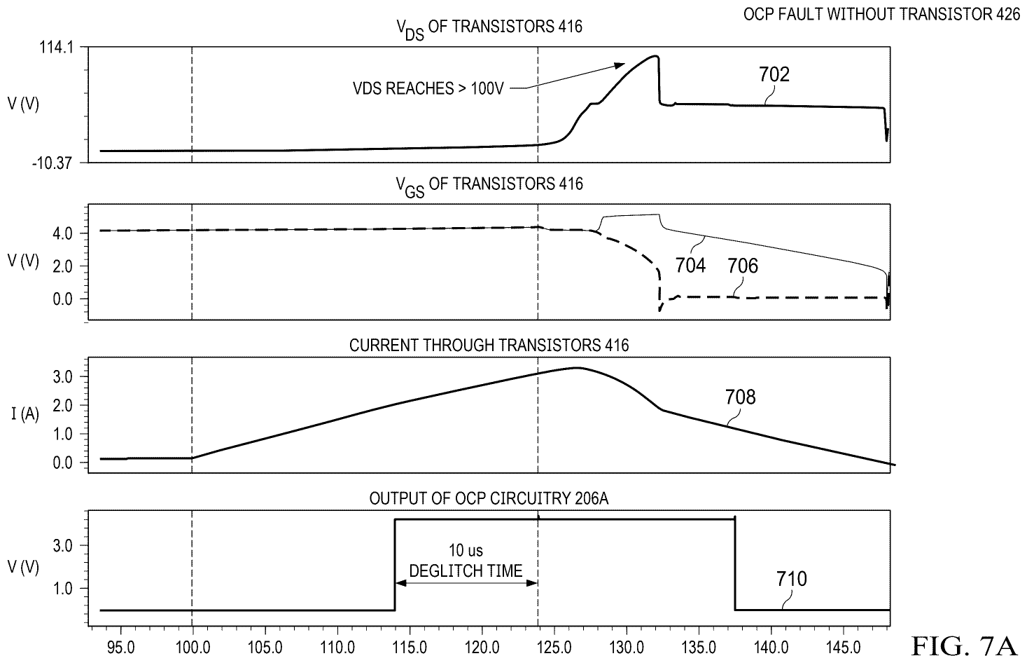

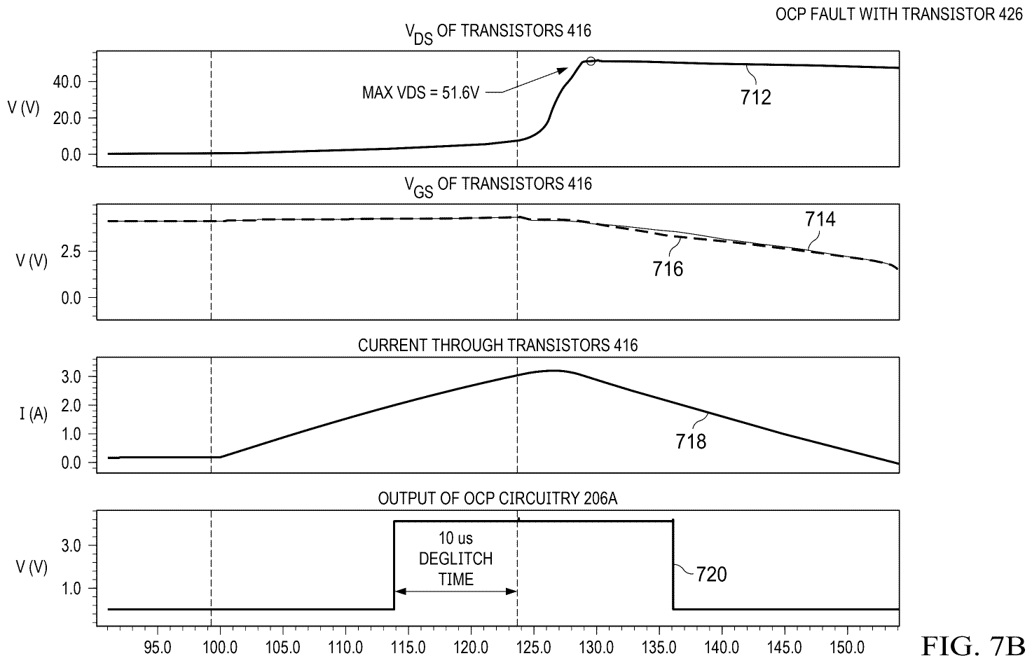

FIG. 7A is an example graph showing the performance of the driver architecture circuitry 202A of FIG. 2 without the transistor 426 during an OCP fault. FIG. 7A includes example signals 702, 704, 706, 708, 710. The signals in FIG. 7A share a common x axis which displays time in microseconds (μs).

The example scenario of FIG. 7A begins at approximately t=95.0 μs with the driver architecture circuitry 202A in power delivery mode as described at FIG. 4A. An OCP fault occurs at approximately t=100 μs. In FIG. 7A, the OCP fault is modeled as a 100 micro-Henry (μH) short in the inductor of the load 110A. The error prevents the load 110A from controlling the amount of current it pulls from the battery 102. Accordingly, the signal 708 shows the current through the transistors 416 begins to increase.

At approximately t=114 μs, the current through the load 110A has increased sufficiently high that the V_{REF} threshold is crossed as described above in connection with FIG. 6. Accordingly, the signal 710 shows output of the comparator circuitry 608 transitions from a logical 0, shown in FIG. 7A as approximately +0.5 V, to a logical 1, shown in FIG. 7A as approximately +3.5 V.

The example of 7A presents a scenario in which the driver architecture circuity 202A does not implement the transistor 426. However, the OCP circuitry 206A does still provide an output to the driver control circuitry 204 in such a scenario. After waiting approximately 10 μs to allow for deglitching of the incoming OCP signal, the driver control circuitry 204 changes PU and PD signals to transition the driver architecture circuitry 202A into clamping mode. The driver control circuitry 204 transitions to clamping mode to dissipate energy from the load 110A and prevent damage to the transistors 416. In some examples, the driver control circuitry 204 communicates with the control circuitry 106 in response to receiving the OCP signal and before transitioning to clamping mode.

The signals 704 and 706 represent V_{GS}, the voltages across the shared source terminal and respective gate terminals of the transistors 416, whose values determine whether which of the respective transistor fingers are powered ON or OFF. In response to entering clamping mode, the signal 704 shows that half of the transistors 416 remain powered ON while, at approximately t=127 μs, the signal 706 shows the other half of the transistors 416 turns OFF because V_{GS} decreases sharply. V_{GS} decreases sharply, in turn, because the transistor 418 turns OFF at approximately t=127 μs in response to entering clamping mode. Turning half of the transistor fingers OFF forces all of the current, which the signal 708 shows has a peak of over 3.0 A, through the transistor fingers that remain powered ON. Forcing such large amounts of current through limited pathways can increase V_{DS}, the voltage across the shared drain terminal and shared source terminal of the transistors 416, past a safe value and damage the transistors 416. For example, the signal 702 shows that reaches above +100 V at approximately t=132 μs. Accordingly, the example of FIG. 7A shows that without the transistor 426, entering clamping mode as described in FIGS. 4B and 5B during an OCP fault can damage the transistors 416 due to overheating. However, some manufacturers or designers may still choose to implement FET splitting mode without the transistor 426 for any reason, including but not limited to a determination that OCP faults are sufficiently rare for a particular use case, a determination that the mechanical stress and degradation caused by a peak in V_{DS} during an OCP fault is acceptable, etc.

FIG. 7B are example graphs showing the performance of the driver architecture circuitry 202A of FIG. 2 with the transistor 426 to support an OCP fault. FIG. 7B shows example signals 712, 714, 716, 718, and 720, which represent the same electrical characteristics of the driver architecture circuitry 202A as the signals 702, 704, 706, 708, and 710 of FIG. 7A, respectively.

Other than the presence of the transistor 426, the example scenarios of FIGS. 7A and 7B have the same exciting conditions. Thus, a 100 μH short occurs at approximately t=100 μs causing an OCP fault, and the driver control circuitry 204 enters clamping mode at approximately t=124 μs. However, because the transistor 426 is present in FIG. 7B, the signal 720 is also received by the driver architecture circuitry 202A and the transistor 426 turns ON at approximately t=114 μs. Accordingly, although the transistor 418 still turns OFF at approximately t=126, current still has a path to reach the gate terminals of the transistors 416D-416F. Thus, the signals 714 and 716 shows that both halves of the transistors 416 remain powered ON. Keeping all transistor fingers powered ON spreads the large amount of current across a larger region, thereby keeping V_{DS} at a safe value. For example, the signal 712 shows V_{DS} reaches a max of 51.6 V instead of exceeding 100 V as shown in FIG. 7A. Accordingly, the example scenario of FIG. 7B shows the transistor 426 lowers V_{DS} and mitigates the risk of the transistors 416 electrothermal breakdown when clamping mode and an OCP fault occur simultaneously.

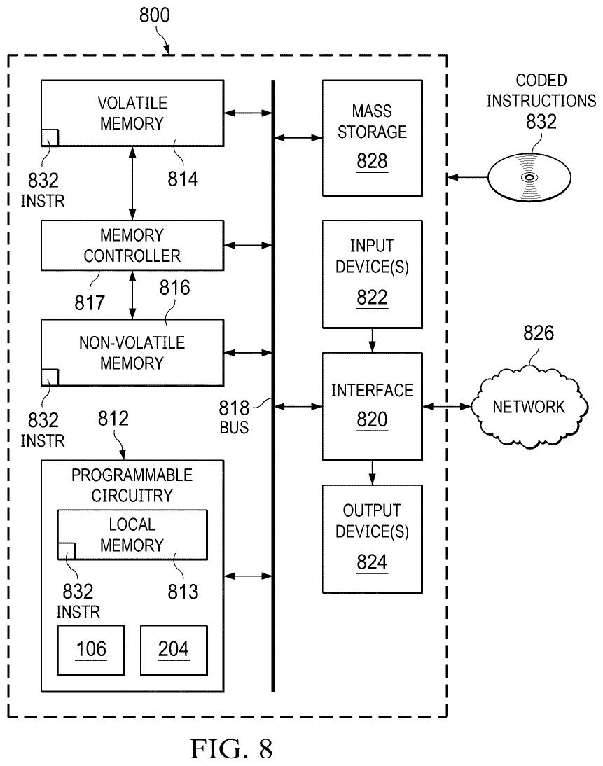

FIG. 8 is a block diagram of an example programmable circuitry platform 800 structured to one or a combination of execute or instantiate one or more of the example machine-readable instructions or the example operations to implement the control circuitry 106 or solenoid driver circuitry 108 of FIG. 1. The programmable circuitry platform 800 can be, for example, a server, a personal computer, a system on a chip (SoC), an Electronic Control Unit (ECU), or any other type of computing or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, or microcontrollers from any desired family or manufacturer. The programmable circuitry 812 may be implemented by one or more semiconductor based (e.g., silicon based) devices. In this example, the programmable circuitry 812 implements one or more of the control circuitry 106 and driver control circuitry 204.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 816 may be implemented by one or a combination of flash memory or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter one of or a combination of data or commands into the programmable circuitry 812. The input device(s) 822 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 824 are also connected to the interface circuitry 820 of the illustrated example. The output device(s) 824 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 820 of the illustrated example, thus, includes one of or a combination of a graphics driver card, a graphics driver chip, or graphics processor circuitry such as a GPU.

The interface circuitry 820 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store one or more of firmware, software, or data. Examples of such mass storage discs or devices 828 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 832, which may be implemented by machine-readable instructions, may be stored in one of or a combination of the mass storage device 828, in the volatile memory 814, in the non-volatile memory 816, or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” “third”, “fourth”, “fifth”, “sixth”, “seventh”, etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third. ” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description.

Modifications are possible in the described embodiments, and other embodiments are possible, within the scope of the claims.

From the foregoing, it will be appreciated that example systems, apparatus, articles of manufacture, and methods have been described that supports both: a) improved power delivery to solenoid loads through transistor fingering and b) rapid power dissipation of the solenoid loads through clamping without overheating. Described systems, apparatus, articles of manufacture, and methods improve the efficiency of using a computing device by separating the fingers of the power FET into two interleaving groups, turning half of the fingers OFF during clamping mode, and providing a parallel path for current to turn half of the fingers back ON if an OCP fault occurs. Described systems, apparatus, articles of manufacture, and methods are also directed to one or more improvement(s) in the operation of a machine such as a computer or other electronic, electromechanical, or mechanical device.

What is claimed is:

1. An apparatus comprising:
voltage clamping circuitry having first, second, third, and fourth terminals;
a first transistor having a gate terminal coupled to the third terminal of the voltage clamping circuitry, a drain terminal coupled to the first terminal of the voltage clamping circuitry, and a source terminal coupled to the second terminal of the voltage clamping circuitry;
a second transistor having a gate terminal, a drain terminal coupled to the drain terminal of the first transistor, and a source terminal coupled to the source terminal of the first transistor; and
a third transistor having a gate terminal coupled to the fourth terminal of the voltage clamping circuitry, a drain terminal coupled to the gate terminal of the first transistor, and a source terminal coupled to the gate terminal of the second transistor.

2. The apparatus of claim 1, further including:
a resistor having a first terminal coupled to the gate terminal of the second transistor and a second terminal; and
a fourth transistor having a gate terminal coupled to the fourth terminal of the voltage clamping circuitry, a drain terminal coupled to the second terminal of the resistor, and a source terminal coupled to the second terminal of the voltage clamping circuitry.

3. The apparatus of claim 1, further including:
a fifth transistor having a gate terminal, a drain terminal, and a source terminal coupled to the gate terminal of the first transistor and the third terminal of the voltage clamping circuitry; and
a sixth transistor having a gate terminal, a drain terminal coupled to the source terminal of the fifth transistor, and a source terminal coupled to the second terminal of the voltage clamping circuitry.

4. The apparatus of claim 1, wherein the apparatus is configured to operate in a power delivery mode that increases an amount of energy in an external device.

5. The apparatus of claim 4, wherein during power delivery mode:
control circuitry is configured to power the first transistor on; and
the voltage clamping circuitry is configured to power the third transistor on; and
current flows from the gate terminal of the first transistor, through the third transistor, and to the gate terminal of the second transistor to power the second transistor on.

6. The apparatus of claim 1, wherein the voltage clamping circuitry includes:
a first Zener diode having a positive terminal coupled to the first terminal of the voltage clamping circuitry and a negative terminal;
a fifth transistor having a gate terminal coupled to the fourth terminal of the voltage clamping circuitry, a drain terminal coupled to the negative terminal of the first Zener diode, and a source terminal coupled to the third terminal of the voltage clamping circuitry;
a second Zener diode having a positive terminal and a negative terminal coupled to the negative terminal of the first Zener diode;
a first resistor having a first terminal coupled to the fourth terminal of the voltage clamping circuitry and a second terminal coupled to the positive terminal of the second Zener diode; and
a second resistor having a first terminal coupled to the fourth terminal of the voltage clamping circuitry and a second terminal coupled the second terminal of the voltage clamping circuitry.

7. The apparatus of claim 6, wherein the apparatus is configured to:
dissipate energy from an inductor during a clamping mode; and
power, responsive to the clamping mode, the first transistor is powered on and the second transistor is powered off to prevent overheating.

8. The apparatus of claim 7, wherein during the clamping mode, the voltage clamping circuitry is configured to:
power the first transistor on by flowing current through the first Zener diode, the fifth transistor and the third terminal of the voltage clamping circuitry; and
power the third transistor on by flowing current through the second Zener diode, the first resistor and the fourth terminal of the voltage clamping circuitry,
power the second transistor off by using the third transistor to prevent current from flowing to the gate terminal of the second transistor.

9. An apparatus comprising:
voltage clamping circuitry having first, second, third, and fourth terminals;
a first transistor having a gate terminal coupled to the third terminal of the voltage clamping circuitry, a drain terminal coupled to the first terminal of the voltage clamping circuitry, and a source terminal coupled to the second terminal of the voltage clamping circuitry;
a second transistor having a gate terminal, a drain terminal coupled to the drain terminal of the first transistor, and a source terminal coupled to the source terminal of the first transistor;
a third transistor having a gate terminal coupled to the fourth terminal of the voltage clamping circuitry, a drain terminal coupled to the gate terminal of the first transistor, and a source terminal coupled to the gate terminal of the second transistor;
a fourth transistor having a gate terminal, a drain terminal coupled to the gate terminal of the first transistor, and a source terminal coupled to the gate terminal of the second transistor; and
Over Current Protection (OCP) circuitry coupled to the gate terminal of the fourth transistor.

10. The apparatus of claim 9, further including:
a resistor having a first terminal coupled to the gate terminal of the second transistor and a second terminal; and
a fifth transistor having a gate terminal coupled to the fourth terminal of the voltage clamping circuitry, a drain terminal coupled to the second terminal of the resistor, and a source terminal coupled to the second terminal of the voltage clamping circuitry.

11. The apparatus of claim 9, further including:
a sixth transistor having a gate terminal, a drain terminal, and a source terminal coupled to the gate terminal of the first transistor and the third terminal of the voltage clamping circuitry; and
a seventh transistor having a gate terminal, a drain terminal coupled to the source terminal of the sixth transistor, and a source terminal coupled to the second terminal of the voltage clamping circuitry.

12. The apparatus of claim 9, wherein the apparatus is configured to:
entering a clamping mode that dissipates power from an external device; and
in response to the clamping mode, power the first transistor on and power the third transistor off.

13. The apparatus of claim 12, wherein to power the third transistor off, the apparatus is configured to power both the third transistor and the fourth transistor off to decouple the gate terminal of the first transistor from the gate terminal of the second transistor.

14. The apparatus of claim 9, wherein the OCP circuitry is configured to:
detect an error that pulls current from both the first transistor and the second transistor; and
transmit, in response to the error, a signal indicative of an OCP fault to the fourth transistor.

15. The apparatus of claim 14, wherein the OCP circuitry is configured to detect the error by comparing an amount of current flowing through the first transistor and an amount of current flowing through the second transistor to a threshold.

16. The apparatus of claim 14, wherein in response to an Over Current Protection (OCP) fault, the apparatus is configured to power both the first transistor and the second transistor on.

17. The apparatus of claim 16, wherein to power the second transistor on, the apparatus is configured to:
power the fourth transistor on, responsive to the OCP fault, so that current flows from the gate terminal of the first transistor, through the fourth transistor, and to the gate terminal of the second transistor.

18. The apparatus of claim 17, wherein:
the apparatus is in a clamping mode during the OCP fault; and
the third transistor is powered off responsive to the clamping mode; and
the fourth transistor is as a parallel path for current flow from the first transistor to the second transistor.

19. An apparatus comprising:
voltage clamping circuitry having a first terminal coupled to a supply voltage terminal, a second terminal coupled to a ground terminal, a third terminal, and a fourth terminal;
a first transistor having a gate terminal coupled to the third terminal of the voltage clamping circuitry, a drain terminal coupled to the supply voltage terminal, and a source terminal coupled to the ground terminal;
a second transistor having a gate terminal, a drain terminal coupled to the supply voltage terminal, and a source terminal coupled to the ground terminal;
a third transistor having a gate terminal coupled to the fourth terminal of the voltage clamping circuitry, a drain terminal coupled to the gate terminal of the first transistor, and a source terminal coupled to the gate terminal of the second transistor;
a resistor having a first terminal coupled to the gate terminal of the second transistor and a second terminal;
a fourth transistor having a gate terminal coupled to the fourth terminal of the voltage clamping circuitry, a drain terminal coupled to the second terminal of the resistor, and a source terminal coupled to the ground terminal;
a fifth transistor having a gate terminal, a drain terminal coupled to the supply voltage terminal, and a source terminal coupled to the third terminal of the voltage clamping circuitry; and
a sixth transistor having a gate terminal, a drain terminal coupled to the source terminal of the fifth transistor, and a source terminal coupled to the ground terminal.

20. The apparatus of claim 19, wherein:
the first transistor is implemented in an integrated circuit as part of a first group of transistor fingers;
the second transistor is implemented in the integrated circuit as a part of a second group of transistor fingers; and
the first group of fingers and second group of fingers are interleaved within a region of the integrated circuit.
